(19) United States
(12) Patent Application Publication
(10) Pub. No.: US 2022/0163934 A1
(43) Pub. Date: May 26, 2022

(54) METHOD AND A SYSTEM FOR CONFIGURING ONE OR MORE DEVICES

(71) Applicant: Carrier Corporation, Palm Beach Gardens, FL (US)

(72) Inventors: Mohan Sugumar, Chennai (IN); Rohit Gordhanbhai Savaliya, Vadodara (IN); Saurav Girepunje, Abhanpur (IN)

(21) Appl. No.: 17/520,819

(22) Filed: Nov. 8, 2021

(30) Foreign Application Priority Data
Nov. 25, 2020 (IN) 202011051283

(51) Int. Cl. G05B 19/042; H04W 12/037

(52) U.S. Cl. CPC G05B 19/042; G05B 2219/25011; H04W 12/037

(57) ABSTRACT

A system and a method for configuring one or more devices installed in a building. The method includes establishing a connection by a mobile device with a first device over a short-range network. The method also includes enabling the first device to determine one or more unconfigured devices by broadcasting a discover message by the first device over the short-range network. The method further includes enabling the first device to configure the one or more unconfigured devices over the short-range network in response to determination of the one or more unconfigured devices.

### FOREIGN PRIORITY

This application claims priority to Indian Patent Application No. 202011051283, filed Nov. 25, 2020, and all the benefits accruing therefrom under 35 U.S.C. § 119, the contents of which in its entirety are herein incorporated by reference.

### TECHNICAL FIELD

The present invention generally relates to building automation system (BAS). More particularly, the invention relates to a system and a method for configuring one or more devices installed in a building.

### BACKGROUND

A number of different devices are installed in a building to maintain ambient temperature and to cater to other requirements inside the building. These devices may be air conditioners, fire detectors, chillers, variable air volume (VAV) units or other such devices. Each of these devices needs to be installed and commissioned in order to make them fully operational.

An existing method of commissioning these devices requires to manually set-up an internet protocol (IP) address, a service set identifier (SSID), a mesh ID and a password. The other existing solution to commission these devices is by using a commissioning tool used by a technician. The technician has to carry the commissioning tool to each and every device installed in the building for the purpose. Further, the technician also has to manually access each device by, say, using a ladder. Usually, there are hundreds and thousands of such devices which are installed in a building and the technician has to manually access each device for commissioning and servicing these devices. Thus, it takes several days or months for the technician to commission such devices in a building. Such a process is a time-consuming task. There is no method to configure these devices automatically without physically access them.

In view of the afore-mentioned problems, there is a need of an efficient system and a method for automatically and simultaneously configuring one or more devices in a building. There is also a requirement to substantially reduce the time taken and manual efforts made by a technician to configure these devices. In order to solve the problems in the existing solutions, a system and a method are disclosed.

### SUMMARY

Various embodiments of the invention describe a method for configuring one or more devices. The method comprises the steps of establishing a connection by a mobile device with a first device over a short-range network. The method also comprises the steps of enabling the first device to determine one or more unconfigured devices by broadcasting a discover message by the first device over the short-range network. The method further comprises the steps of enabling the first device to configure the one or more unconfigured devices over the short-range network in response to determination of the one or more unconfigured devices.

In an embodiment of the invention, the method also comprises the step of communicating the first device and the one or more unconfigured devices with different broadcast and/or unicast commands over the short-range network. The broadcast and/or unicast commands are transmitted over a data frame to configure the one or more unconfigured devices.

In a different embodiment of the invention, the short-range network is a Wi-Fi network.

In an embodiment of the invention, the first device transmits an encrypted configuration information to the one or more unconfigured devices for configuring the one or more unconfigured devices. Also, the one or more unconfigured devices decrypt the encrypted configuration information.

In another embodiment of the invention, the first device is enabled to transmit a blink command to one or more configured devices to locate or identify the configured devices.

In yet another embodiment of the invention, the method further comprises the step of changing from an unconfigured status to a configured status of the one or more unconfigured devices after configuring the one or more unconfigured devices.

In another embodiment of the invention, the first device is connected to a short-range network dongle for communicating with the mobile device over the short-range network.

In still another embodiment of the invention, the first device configures the one or more unconfigured devices simultaneously and/or iteratively over the short-range network.

In a different embodiment of the invention, the configuration of the first device by the mobile device and the configuration of the one or more unconfigured devices by the first device is performed at a data link layer.

In yet another embodiment of the invention, the first device determines the one or more unconfigured devices when the first device receives an identity message from the one or more unconfigured devices.

In an embodiment of the invention, the first device reconfigures and/or unconfigures one or more configured devices.

Various embodiments of the invention describe a method for configuring one or more devices. The method comprises the steps of connecting a first device to a mobile device over a short-range network and determining one or more unconfigured devices by broadcasting a discover message by the first device over the short-range network. The method further comprises the steps of receiving an identity message from the one or more unconfigured devices in response to the discover message and configuring the one or more unconfigured devices over the short-range network in response to receiving the identity message.

In an embodiment of the invention, the method also comprises the steps of receiving an acknowledgment message after configuring the one or more unconfigured devices.

Various embodiments of the invention describe a system for configuring one or more devices. The system comprises a mobile device and a first device. The mobile device is configured to establish a connection with a first device over a short-range network. The first device is configured to determine one or more unconfigured devices by broadcasting a discover message over the short-range network. The first device is also configured to receive an identity message from the one or more unconfigured devices in response to the discover message. The first device is further configured to configure the one or more unconfigured devices in response to receiving the identity message.

In a different embodiment of the invention, the mobile device communicates with the first device and the one or more unconfigured devices with different broadcast and/or unicast commands over the short-range network. Also, the broadcast and/or unicast commands are transmitted over a data frame to configure the one or more unconfigured devices.

In yet another embodiment of the invention, the mobile device enables the first device to reconfigure and/or unconfigure one or more configured devices.

In an embodiment of the invention, the first device transmits an encrypted configuration information to the one or more unconfigured devices for configuring the one or more unconfigured devices. The one or more unconfigured devices decrypt the encrypted configuration information.

In another embodiment of the invention, the first device is configured to change from an unconfigured status to a configured status of the one or more unconfigured devices after configuring the one or more unconfigured devices.

In yet another embodiment of the invention, the configuration of the first device by the mobile device and the configuration of the one or more unconfigured devices by the first device is performed at a data link layer.

In another different embodiment of the invention, a computer readable medium is disclosed for configuring one or more devices. The computer readable medium comprises one or more processors and a memory is coupled to the one or more processors, the memory stores instructions executed by the one or more processors. The one or more processors are configured to connect a first device to a mobile device over a short-range network and to determine one or more unconfigured devices by broadcasting a discover message by the first device over the short-range network. The one or more processors are further configured to receive an identity message from the one or more unconfigured devices in response to the discover message and configure the one or more unconfigured devices over the short-range network in response to receiving the identity message.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1A depicts an exemplary system architecture according to an exemplary embodiment of the invention.

FIG. 1B depicts an exemplary communication between a mobile device and a first device according to an exemplary embodiment of the invention.

FIG. 1C depicts an exemplary signaling diagram between a first device and one or more configured/unconfigured devices according to an exemplary embodiment of the invention.

FIGS. 1D to 1I depict exemplary screenshots of an interface of an application in the mobile device.

FIG. 2 depicts block diagram of different components of an exemplary mobile device according to an exemplary embodiment of the invention.

FIG. 3 depicts block diagram of different components of an exemplary first device according to an exemplary embodiment of the invention.

FIG. 4 depicts an exemplary flowchart illustrating a method implemented by a mobile device to perform the invention according to an exemplary embodiment of the invention.

FIG. 5 depicts an exemplary flowchart illustrating a method implemented by a first device to perform the invention according to an exemplary embodiment of the invention.

Corresponding reference numerals indicate corresponding parts throughout the drawings.

### DETAILED DESCRIPTION OF THE INVENTION

Described herein is the technology with a system and a method for configuring one or more devices. One or more devices may be installed in each floor of a building. These devices, if are currently unconfigured, can be configured by a mobile device operated by using an application. The mobile device may establish a connection with a first device from the one or more devices using a short-range network. The mobile device may be operated by a person/technician who can use the application in the mobile device to connect with the first device. Once the connection with the first device is established, the first device is enabled to communicate with rest of unconfigured devices installed in the building. The communication between the first device and the unconfigured devices takes place through the short-range network. Several different kinds of messages can be exchanged between the first device and the unconfigured devices to configure the unconfigured devices in the building. The explanation of these messages have been provided below in detail.

As used herein, the one or more devices may be installed in a building and may comprise a first device, one or more configured devices, and one or more unconfigured devices. The first device may be considered as a master device which is connected directly with the mobile device through the short-range network. The one or more configured devices may be devices which are already or previously configured by a technician/person. The one or more unconfigured devices may be devices which are unconfigured and are yet to be configured by the first device. These one or more unconfigured devices may be considered as slave devices communicating with the first device (which may be considered as a master device) through the short-range network. The first device, the one or more configured devices and the one or more unconfigured devices may other through BACnet communication protocol used for building automation and control (BAC) networks which is well known in the communicate with each art. In an exemplary embodiment, each of the first device and the one or more unconfigured devices is a controller of a heating, ventilating, and air-conditioning control (HVAC) system, a chiller system, a lighting control system, an access control system, and a fire detection system and their associated equipment. The first device may be already configured device or can be configured to be used as a gateway or an access point using the application to communicate with the one or more unconfigured devices.

As used herein, the short-range network may be a WiFi network, a bluetooth network, a ZigBee network, a near-field communication network, or any such network that is known or obvious to a person skilled in the art.

Throughout the specification, reference numeral 106 depicts all devices. The reference numerals 106A-106E (106) may be considered as separate devices. Similarly, throughout the specification, reference numeral 104 depicts all floors. The reference numerals 104A-104D (104) may be considered as a separate floor.

The network described herein may use a message format as per the technological requirement/protocol of the network. As an example, for Wi-Fi network the message format is the one used as a 802.11 Data Frame comprising a header and a payload. The message format used herein is configured in the payload of the 802.11 data frame. The present invention uses novel message format in the payload as will be described herein below.

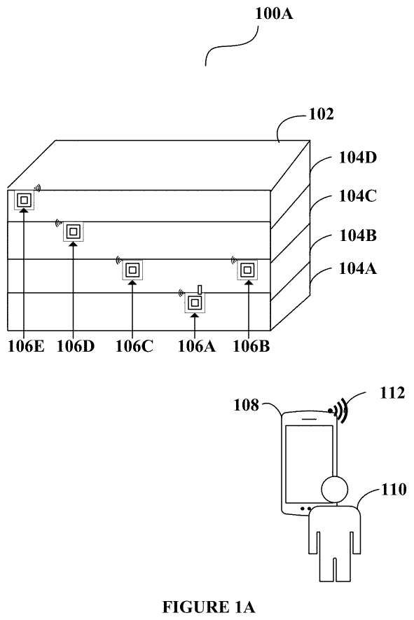

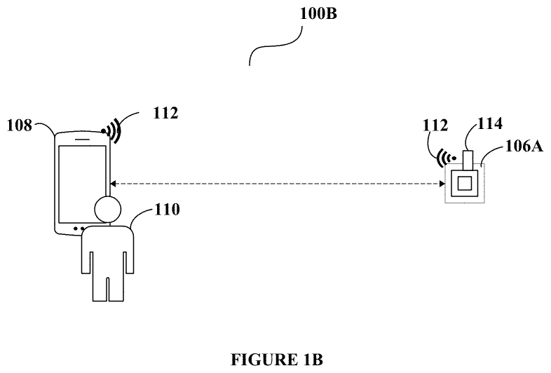

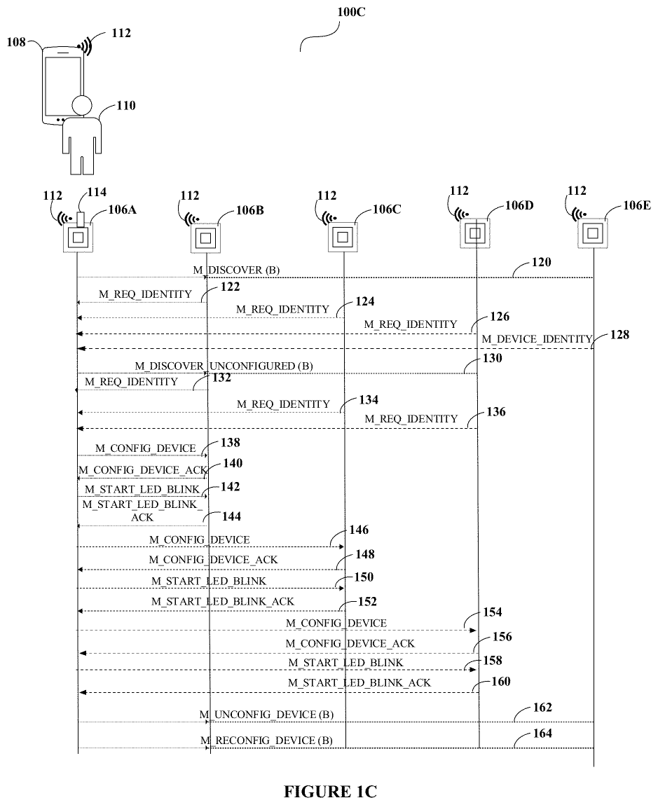

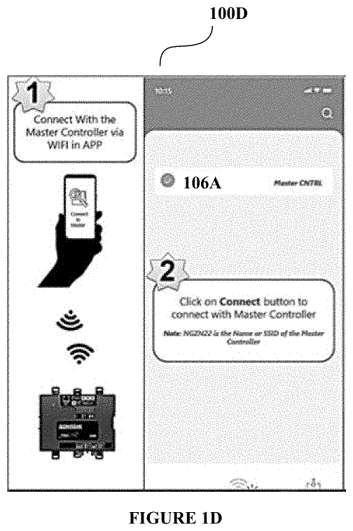

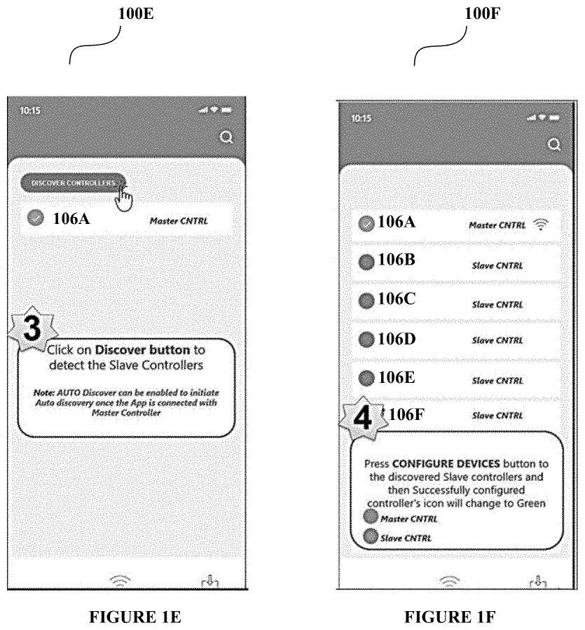

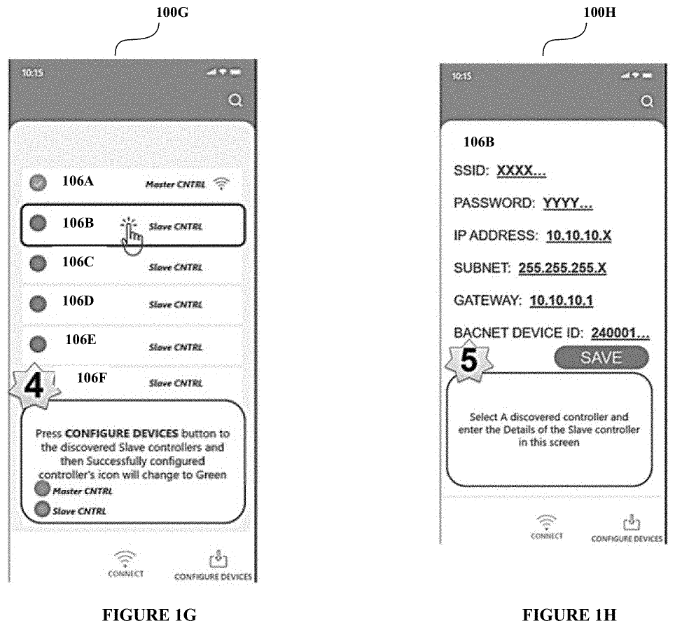

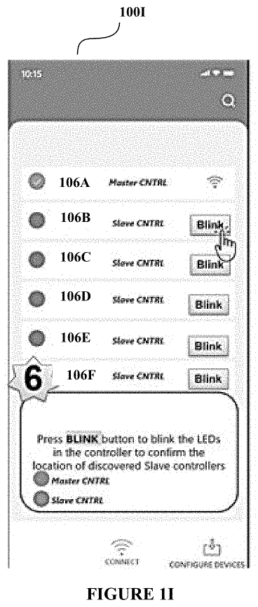

FIG. 1A depicts an exemplary system architecture 100A according to an exemplary embodiment of the invention. As depicted in FIG. 1A, a building/premises 102 may have a first floor 104A, a second floor 104B, a third floor 104C and a fourth floor 104D. Each of the floor 104 may have one or more devices 106. As can be seen in FIG. 1A, on the first floor 104A, one device 106A may be installed and on the second floor 104B, two devices 106B and 106C may be installed. Similarly, on the third floor 104C, one device 106D may be installed and on the fourth floor 104D, one device 106E may be installed. Although, the building 102 has only four floors 104A-104D; however, it is understood for a person skilled in the art that the building 102 may have more or less number of floors. Likewise, only five devices 106A-106E have been shown in the floors 104 of the building 102 for brevity, however, it is understood for a person skilled in the art that any number of devices may be present at each floor 104.

Further, a mobile device 108 having an application may be operated by a person/technician 110 and may be connected with a short-range network 112. Furthermore, the person 110 may select any device from the one or more devices 106 installed at the respective floor 104 of the building 102 to connect with the mobile device 108. For this, the person 110 may make any device as a first/master device by connecting or plugging-in a dual in-line package (DIP) switch or a hardware switch to that particular device. Thereby, such device can act as an access point. The selected device by the person 110 can thus be connected to the mobile device 108 and is referred hereinafter as a first device. Considering an example where the person 110 selects the device 106A installed at the first floor 104A for connecting the mobile device 108 with the device 106A and thus called a first device 106A or a master device. The connection between the first device 106A and the mobile device 108 is password protected. Although, the person 110 has selected the device 106A as the first device from the one or more device 106A-106E; however, it is understood for a person skilled in the art that any other device from the one or more device 106A-106E can also be chosen as the first device. The communication between the mobile device 108 with the first device 106A has been explained in FIG. 1B below.

FIG. 1B depicts an exemplary communication 100B between the mobile device 108 and the first device 106A according to an exemplary embodiment of the invention. As depicted in FIG. 1B, the mobile device 108 is connected with a short-range network 112. Further, the first device 106A (the master device) is connected to a short-range dongle 114 which provides a short-range network 112 to the first device 106A to communicate with the mobile device 108. In an exemplary embodiment, the short-range dongle 114 is a Wi-Fi dongle. Using the short-range network 112, the mobile device 108 may establish a connection with the first device 106A. To establish the connection with the first device 106A, the person 110 may use the application stored and executing in the mobile device 108 to connect with the selected first device 106A. FIG. 1D depicts an interface of the application showing a “Connect” button to establish a connection between the mobile device 108 to the first device 106A. Further, communication between the mobile device 108 and the first device 106A is through REST (Representational State Transfer) API (Application Programming Interface) via XML/HTML (Extensible Markup Language or Hyper Text Markup Language) format. The first device 106A has an in-built web server and that can be accessed by a web browser or the application in the mobile device 108 to configure the first device 106A.

In an exemplary embodiment, the first device 106A can be an already configured device or an unconfigured device. In case the first device 106A is an already configured device, the person 110 may use the application in the mobile device 108 to enable the first device 106A to configure other one or more devices 106B-106E. And, if the first device 106A is an unconfigured device, the person 110 may use the application in the mobile device 108 to first configure the first device 106A and then enable the first device 106A to configure other one or more unconfigured devices 106B-106E (or slave devices). In an exemplary embodiment, the first device 106A is configured using the application in the mobile device 108 or by connecting or plugging-in a dual in-line package (DIP) switch or a hardware switch to the first device 106A. The details on how the first device 106A configures the other one or more devices 106B-106E is provided in FIG. 1C below.

FIG. 1C depicts an exemplary signalling diagram 100C between the first device 106A and the one or more devices 106B-106E according to an exemplary embodiment of the invention. Once the mobile device 108 is connected with the first device 106A through the short-range network 112, the person 110 may use the application in the mobile device 108 to enable the first device 106A to configure other one or more devices 106B-106E.

After the mobile device 108 connects with the first device 106A, the first device 106A may broadcast a network name (SSID). Other devices 106B-106E may monitor wireless traffic over the air and extract the network name broadcasted by the first device 106A. Once the devices 106B-106E extract the network name, the devices 106B-106E may then connect with the same network 112. This wireless connection may be an open connection, that is, there is no passphrase/password to connect but data exchange happens securely using a symmetric key. Thus, each of the one or more devices 106B-106E may also be connected with the first device 106A through the short-range network.

At step 120, the first device 106A may broadcast a M_DISCOVER message to all other one or more devices 106B-106E through the short-range network 112. This may be done when the person 110 selects an “Auto Discovery Mode” provided in the application to discover all configured and the unconfigured devices 106 in the building 102. Further, the person 110 may select the “Auto Discovery Mode” after the mobile device 108 is connected to the first device 106A. FIG. 1E depicts an interface of the application executing on the mobile device 108 showing a “Discover” button to discover all configured and the unconfigured devices 106.

Table 1 below describes contents of or information present in the M_DISCOVER message. The M_DISCOVER message contains a hardware address of the first device 106A and padding bytes.

TABLE 1
Contents of M_DISCOVER message

M_IE_HARDWARE_ADDR
M_IE_PAD_BYTES

At step 122, in response to the M_DISCOVER message, the device 106B transmits a M_REQ_IDENTITY message (i.e. an identity message) to the first device 106A through the short-range network 112. Table 2 below describes contents of or information in the M_REQ_IDENTITY message. The M_REQ_IDENTITY message contains a hardware address of the device 106B, a vendor identifier of the device 106B, a device identifier of the device 106B, a serial number of the device 106B, a location of the device 106B and padding bytes.

TABLE 2
Contents of M_REQ_IDENTITY message

M_IE_HARDWARE_ADDR
M_IE_VENDOR_ID
M_IE_DEVICE_ID
M_IE_SERIAL_NUM
M_IE_DEVICE_LOCATION
M_IE_PAD_BYTES

In the similar manner, at step 124, in response to the M_DISCOVER message, the device 106C transmits a M_REQ_IDENTITY message to the first device 106A through the short-range network 112. At step 126, in response to the M_DISCOVER message, the device 106D transmits a M_REQ_IDENTITY message to the first device 106A through the short-range network 112.

And, at step 128, in response to the M_DISCOVER message, the device 106E transmits a M_DEVICE_IDENTITY message to the first device 106A through the short-range network 112. Table 3 below describes contents of or information in the M_DEVICE_IDENTITY message. As the device 106E is an already configured device, the M_DEVICE_IDENTITY message sent by the device 106E contains a hardware address of the configured device 106E, a vendor identifier of the configured device 106E, a device identifier of the configured device 106E, a serial number of the configured device 106E, a location of the configured device 106E, an interne protocol (IP) address of the configured device 106E, credentials of the configured device 106E and padding bytes.

TABLE 3
Contents of M_DEVICE_IDENTITY message

M_IE_HARDWARE_ADDR
M_IE_VENDOR_ID
M_IE_DEVICE_ID
M_IE_SERIAL_NUM
M_IE_DEVICE_LOCATION
M_IE_IP_PARA
M_IE_CRED
M_IE_PAD_BYTES

When the first device 106A receives the M_REQ_IDENTITY message and/or the M_DEVICE_IDENTITY message from all devices 106B-106E, the first device 106A may identify unconfigured devices 106B-106D and configured device 106E based on the configuration status of such devices 106. For an instance, the first device 106A identifies that the device 106E is a configured device and other devices 106B-104D are unconfigured devices.

At step 130, the first device 106A may also broadcast a M_DISCOVER_UNCONFIGURED message to all the one or more unconfigured devices 106B-106D through the short-range network 112. This is done when the person 110 selects an “Start Discovering Un-configured” provided in the application to discover all the unconfigured devices 106 in the building 102. This step 130 is different from the step 120 as at step 120, all the configured and unconfigured devices are discovered by the first device 106A and at step 130, only the unconfigured devices discovered by the first device 106A. When the device 106A broadcasts the M_DISCOVER_UNCONFIGURED message, the configured device 106E does not respond as this message is only intended for the unconfigured devices 106B-106D.

Table 4 below describes contents of or information in the M_DISCOVER_UNCONFIGURED message. The M_DISCOVER_UNCONFIGURED message contains a hardware address of the first device 106A and padding bytes.

TABLE 4
Contents of M_DISCOVER_UNCONFIGURED message

M_IE_HARDWARE_ADDR
M_IE_PAD_BYTES

At step 132, in response to the M_DISCOVER_UNCONFIGURED message, the unconfigured device 106B transmits a M_REQ_IDENTITY message (i.e. an identity message) to the first device 106A through the short-range network 112. The contents of the M_REQ_IDENTITY message is explained above in table 2.

In the similar way, at step 134, the unconfigured device 106C transmits a M_REQ_IDENTITY message to the first device 106A through the short-range network 112. At step 136, in response to the M_DISCOVER_UNCONFIGURED message, the unconfigured device 106D transmits a M_REQ_IDENTITY message to the first device 106A through the short-range network 112. When the first device 106A receives the M_REQ_IDENTITY message from all unconfigured devices 106B-106D, the first device 106A may then communicate only with the unconfigured devices 106B-104D.

At step 138, the first device 106A may transmit (unicast) a M_CONFIG_DEVICE message to the unconfigured device 106B through the short-range network 112. For this, the person 110 may enter a configuration information (such as password etc.) in the application stored in the mobile device 108 and subsequently click on a “Save” option provided in the application. This message enables the first device 106A to transmit an encrypted configuration information to the unconfigured device 106B. Such an encrypted configuration information may comprise, but is not limited to, an internet protocol (IP) subnet address, a default gateway, a location, and/or credentials/password. FIG. 1F depicts an interface of the application showing a “Configure Devices” button to configure one or more unconfigured devices 106B-106E. FIG. 1G depicts an interface of the application showing a selection of the unconfigured device 106B by the person 110 to configure this device 106B. FIG. 1H depicts an interface of the application showing the person 110 entering the configuration information in the application and showing a “Save” button for saving the configuration information.

When the unconfigured device 106B receives the M_CONFIG_DEVICE message, the unconfigured device 106B may decrypt the encrypted configuration information and implement the decrypted configuration information. Implementing the configuration information by the unconfigured device 106B would configure the unconfigured device 106B. It is within the scope of the present invention that the first device 106A may transmit the same configuration information to the unconfigured device 106B which is also used by the first device 106A as its configuration information. In other words, the first device 106A and the unconfigured device 106B may be configured using the same configuration information. It is also within the scope of the present invention that different configuration information is used for configuring the first device 106A and the unconfigured device 106B. Also, the configuration information is encrypted and decrypted using symmetric key algorithms to help in data security that is well known in the art.

Table 5 below describes contents of or information in the M_CONFIG_DEVICE message. The M_CONFIG_DEVICE message contains a hardware address of the device 106B, a device identifier of the device 106B, a serial number of the device 106B, a location of the device 106B, an internet protocol (IP) address, credentials, and padding bytes.

TABLE 5
Contents of M_CONFIG_DEVICE message

M_IE_HARDWARE_ADDR
M_IE_DEVICE_ID
M_IE_SERIAL_NUM
M_IE_DEVICE_LOCATION
M_IE_IP_PARA
M_IE_CRED
M_IE_PAD_BYTES

At step 140, in response to the M_CONFIG_DEVICE message, the unconfigured device 106B may transmit a M_CONFIG_DEVICE_ACK message to the first device 106A through the short-range network 112. The M_CONFIG_DEVICE_ACK message may provide an acknowledgment to the first device 106A that the unconfigured device 106B has implemented the configuration information and thus, has now become a configured device.

Table 6 below describes contents of or information present in the M_CONFIG_DEVICE_ACK message. The M_CONFIG_DEVICE_ACK message contains a hardware address of the device 106B, a device identifier of the device 106B, a serial number of the device 106B, a location of the device 106B, an internet protocol (IP) address, credentials, and padding bytes.

TABLE 6
Contents of M_CONFIG_DEVICE_ACK message

M_IE_HARDWARE_ADDR
M_IE_DEVICE_ID
M_IE_SERIAL_NUM
M_IE_DEVICE_LOCATION
M_IE_IP_PARA
M_IE_CRED
M_IE_PAD_BYTES

At step 142, the first device 106A may transmit (unicast) a M_START_LED_BLINK message to the unconfigured device 106B through the short-range network 112. When the person 110 initiates LED blink sequence from the application, the M_START_LED_BLINK message enables the first device 106A to unicast a message to configured device 106B to locate or identify newly configured device 106B. FIG. 1I depicts an interface of the application showing a “Blink” button which the person 110 selects for locating and identifying the configured device 106B in the building 102.

Table 7 below describes contents of or information in the M_START_LED_BLINK message. The M_START_LED_BLINK message contains a hardware address of the device 106B, a device identifier of the device 106B, a serial number of the device 106B and padding bytes.

TABLE 7
Contents of M_START_LED_BLINK message

M_IE_HARDWARE_ADDR
M_IE_DEVICE_ID
M_IE_SERIAL_NUM
M_IE_PAD_BYTES

At step 144, in response to the M_START_LED_BLINK message, the unconfigured device 106B may start blinking on receiving the M_START_LED_BLINK message (i.e. a blink command) and may also transmit a M_START_LED_BLINK_ACK message to the first device 106A through the short-range network 112. The M_START_LED_BLINK_ACK message may provide an acknowledgment to the first device 106A that the M_START_LED_BLINK is successfully received by the configured device 106B.

Table 8 below describes contents of or information in the M_START_LED_BLINK_ACK message. The M_START_LED_BLINK_ACK message contains a hardware address of the device 106B, a device identifier of the device 106B, a serial number of the device 106B and padding bytes.

TABLE 8
Contents of M_START_LED_BLINK_ACK message

M_IE_HARDWARE_ADDR
M_IE_DEVICE_ID
M_IE_SERIAL_NUM
M_IE_PAD_BYTES

In the same manner, from step 146 to step 152, the unconfigured device 106C can be configured and starts blinking by sharing the messages as explained above for the unconfigured device 106B. Similarly, from step 154 to step 160, the unconfigured device 106D can be configured and starts blinking.

After configuring the unconfigured devices 106B-106D, the first device 106A may change from an unconfigured status to a configured status of the unconfigured device 106B-106D as these devices 106B-106D have been successfully configured by the first device 106A.

All the messages between the first device 106A and the mobile device 108 as well as between the first device 106A and the configured as well unconfigured device 106B-106DE are exchanged (either unicast or broadcast over a data frame to configure the one or more unconfigured devices) using a data link layer through their respective short-range network 112. Thus, the present invention also encompasses the first device 106A and the application in the mobile device 108 to perform the configuration of the one or more unconfigured devices 106B-106D by the first device 106A at the data link layer.

Thereby, the present invention enables the first device 106A to simultaneously and/or iteratively configure the one or more unconfigured devices 106B-106D over the short-range network 112. By configuring all the unconfigured devices 106B-106D through the first device 106A, there is no need to manually configure each device 106 and the time taken for configuring these devices 106B-106C is reduced to a larger extent. The present invention also solves accessibility problems, for instance eliminates the need to use a ladder by the person 110 to configure these device 106B-106D as these devices can be configured using the application in the mobile device 108.

The present invention further encompasses the person 110 to unconfigure an already configured device 106E. For this, the person 110 may open the application in the mobile device 108 and may enable the first device 106A to unconfigure the already configured device 106E. At step 162, the first device 106A may transmit a M_UNCONFIG_DEVICE message to the already configured device 106E and upon receiving the M_UNCONFIG_DEVICE message, the already configured device 106E may uninstall already implemented configuration information for becoming an unconfigured device.

The present invention further encompasses the person 110 to reconfigure an already configured device 106E. For this, the person 110 may open the application in the mobile device 108 and may enable the first device 106A to reconfigure the already configured device 106E. At step 164, the first device 106A may transmit a M_RECONFIG_DEVICE message to the already configured device 106E and upon receiving the M_RECONFIG_DEVICE message, the already configured device 106E may be reconfigured by the person 110 by implementing new configuration information on the configured device 106E.

Table 9 below describes contents of or information in the M_UNCONFIG_DEVICE message. The M_UNCONFIG_DEVICE message contains a hardware address of the device 106E, a device identifier of the device 106E, a serial number of the device 106E and padding bytes.

TABLE 9
Contents of M_UNCONFIG_DEVICE message

M_IE_HARDWARE_ADDR
M_IE_DEVICE_ID
M_IE_SERIAL_NUM
M_IE_PAD_BYTES

Each of the above explained Wi-Fi data link layer messages exchanged between the first device 106A and the one or more configured and unconfigured devices 106B-106E may have the following message format as provided in Table 10 below.

TABLE 10

| Byte | Message Format |
|---|---|
| 8 | Magic Bytes (Sequence bytes with value 0x33 |
| | followed by ‘Start of message’) |
| 20 | Serial Number of First Device 106A |
| 20 | Serial Number of Unconfigured/Configured |
| | Device (All are set 1 during broadcast) |
| 1 | Message Type |
| 2 | Message Data Length |
| 4 | Sequence Number of Packet |
| X | Message Data (may contain multiple |
| | Information elements) |
| 2 | Frame Check Sum |

Further, each of the above explained Wi-Fi data link layer messages exchanged between the first device 106A and the one or more configured and unconfigured devices 106B-106E may have the following message address format as provided in Table 11 below.

TABLE 11

| | Message Type Format | | | | | | | |
|---|---|---|---|---|---|---|---|---|
| Bits | BIT7 | BIT6 | BIT5 | BIT4 | BIT3 | BIT2 | BIT1 | BIT0 |

| | |
|---|---|
| Ack/ | 7 Bit Message Code |
| Nack | |

Table 12 provided below depicts magic bytes (8 bytes) format which is part of the message format as explained in Table 10 above.

TABLE 12

| Byte | Magic Bytes |
|---|---|
| 1 | 0x33 |
| 2 | 0x33 |
| . . . | |
| 7 | 0x33 |
| 8 | Start of Message (0x4D) |

Table 13 provided below shows a fixed length information element which is part of the message format as explained in Table 10 above.

TABLE 13

| Byte | Information Element Format |
|---|---|
| 1 | Information Element Code |
| X | Fixed Length Data |

Table 14 provided below shows a variable length information element which is part of the message format as explained in Table 10 above.

TABLE 14

| Byte | Information Element Format |
|---|---|
| 1 | Information Element Code |
| 1 | Data Length |
| X | Data |

Table 15 provided below shows details on different information elements which is part of the message format as explained in Table 10 above.

TABLE 15

| | | Type | |
|---|---|---|---|
| | | [FL: Fixed | |
| | | Length | Length/ |
| | | VL: Variable | Maximum |
| Information Element | Description | Length] | Length |
| M_IE_TRANS_ID | Transaction | FL | 4 |
| | Identification | | |
| M_IE_VENDOR_ID | Vendor ID of Device | FL | 2 |
| | 106 | | |
| M_IE_DEVIC_ID | Mobile Device 108 ID | FL | 4 |
| M_IE_SERIAL_NUM | Serial Number of | VL | 50 |
| | Device 106 | | |
| M_IE_LOCATION_ | Location Name of | VL | 50 |
| NAME | Device 106 | | |
| M_IE_IP_PARA | IP address, Subnet | FL | 4 |
| | Mask, Default Gateway | | |
| M_IE_HARDWARE_ | MAC Address | FL | 6 |
| ADDR | | | |
| M_IE_TRANS_ | Transaction Status | FL | 1 |
| STATUS | | | |
| MI_IE_CRED | Credentials | VL | 70 |
| | SSID/Mesh ID and | | |
| | Password for wireless | | |
| | connection | | |
| M_IE_PAD_BYTES | To add Pad bytes to | VL | 255 |
| | make Ethernet message | | |
| | length at least | | |
| | minimum of 64 bytes | | |

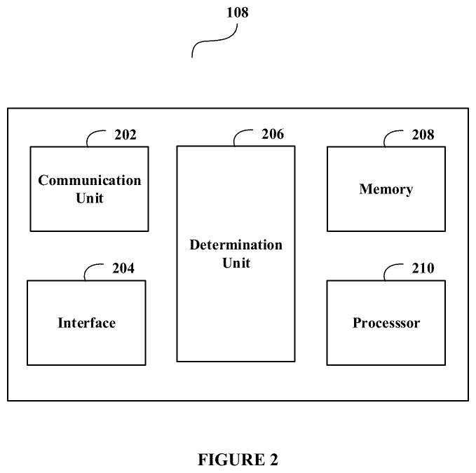

FIG. 2 depicts an exemplary embodiment of the invention. The mobile device 108 may comprise of, but is not limited to, a communication unit 202, an interface 204, a determination unit 206, a memory 208, and/or a processor 210. The communication unit 202 may be adapted to establish a connection with a first device 106A through a short-range network 112. The communication unit 202 may also be adapted to communicate messages (as explained above) to the first device 106A through the short-range network 112. The interface 204 may be adapted to display an interface of an application using which any device can be selected by a person 110 as a first device as explained above. Using the interface 204, the first device 106A may be enabled to communicate with other devices 106B-106E as discussed above. The determination unit 206 may be adapted to determine configured and unconfigured devices 106B-106E based on a M_REQ_IDENTITY and/or a M_DEVICE_IDENTITY messages from the configured and unconfigured devices 106B-106E. The memory 208 may be adapted to store the application through which the mobile device 108 and the first device 106A communicates. The processor 210 may be adapted to perform functions/operations as discussed herein.

Moreover, the communication unit 202, the interface 204, the determination unit 206, and the memory 208 may be communicably coupled with the processor 210. The different units described herein are exemplary. The invention may be performed using one or more units. For example, the tasks executed by the communication unit 202, the interface 204, the determination unit 206, and the memory 208 and/or the processor 210 may be performed by a single unit. Alternatively, more number of units as described herein may be used to perform the present invention.

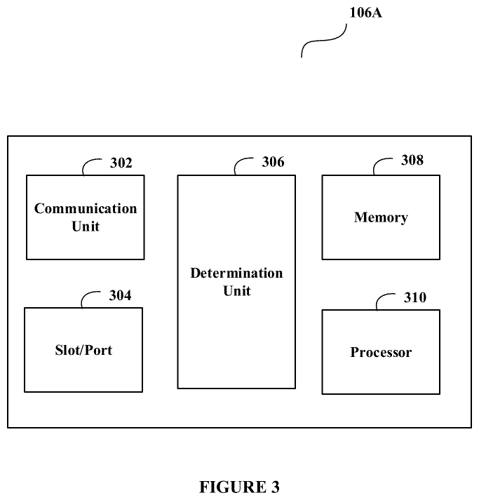

FIG. 3 depicts block diagram of different components of an exemplary first device 106A according to an exemplary embodiment of the invention. The first device 106A may comprise of, but is not limited to, a communication unit 302, a slot/port 304, a determination unit 306, a memory 308, and/or a processor 310. The communication unit 302 may be adapted to establish a connection with one or more configured and unconfigured 106B-106E through a short-range network 112. The communication unit 202 may also be adapted to communicate messages (as explained above) to the one or more configured and unconfigured devices 106B-106E through the short-range network 112. The slot/port 304 may be adapted to receive a short-range dongle (i.e. WiFi dongle) for providing the short-range network 112 to the first device 106A. The determination unit 306 may be adapted to determine the configured and unconfigured devices 106B-106E based on a M_REQ_IDENTITY and/or a M_DEVICE_IDENTITY messages received by the first device 106A from the configured and unconfigured devices 106B-106E. The memory 308 may be adapted to store configuration status of each of the configured and unconfigured 106B-106E. The processor 310 may be adapted to perform operations as discussed herein. It is to be noted that the other configured and unconfigured devices 106B-106E may comprise a communication unit, a slot/port, a determination unit, a memory and/or a processor working in the similar way as that of components/modules of the first device 106A. The determination unit 306 in FIG. 3 have functions similar to determination unit 206 of FIG. 2. It may be a design choice whether to include the determination unit in the mobile device 108 or the first device 108 or both.

Moreover, the communication unit 302, the slot/port 304, the determination unit 306, and/or the memory 308 may be communicably coupled with the processor 310. The different units described herein are exemplary. The invention may be performed using one or more units. For example, the tasks executed by the communication unit 302, the slot/port 304, the determination unit 306, the memory 308 and/or the processor 310 may be performed by a single unit. Alternatively, more number of units as described herein may be used to perform the present invention.

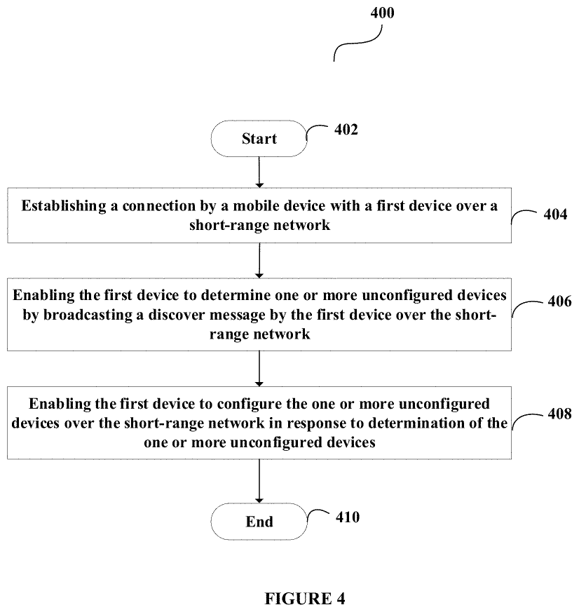

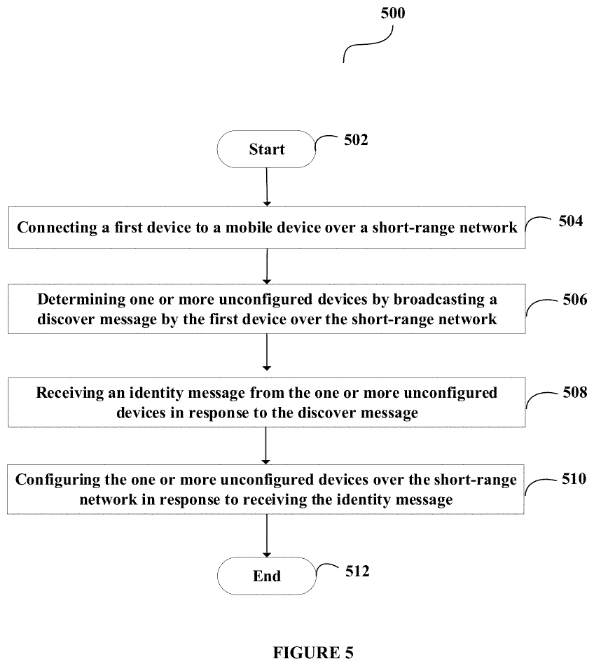

FIG. 4 depicts a flowchart outlining the features of the invention in an exemplary embodiment of the invention. The method flowchart 400 describes a method being performed by a mobile device 108 for configuring one or more unconfigured devices 106B-106D. The method flowchart 400 starts at step 402.

At step 404, an application in the mobile device 108 may establish a connection with a first device 106A over a short-range network 112. This has been discussed in greater details in FIGS. 1A, 1B and 1C above.

At step 406, the application in the mobile device 108 may enable the first device 106A to determine one or more unconfigured devices 106B-106D by broadcasting a discover message (i.e. M_DISCOVER_UNCONFIGURED) by the first device 106A over the short-range network 112. This has been discussed in greater details in FIGS. 1A, 1B and 1C above.

At step 408, the application in the mobile device 108 may enable the first device 106A to configure the one or more unconfigured devices 106B-106D over the short-range network 112 in response to determination of the one or more unconfigured devices 106B-106D. This has been discussed in greater details in FIGS. 1A, 1B and 1C above. Then, the method flowchart 400 may end at 410.

FIG. 5 depicts a flowchart outlining the features of the invention in an exemplary embodiment of the invention. The method flowchart 500 describes a method being performed by a first device 106A for configuring one or more unconfigured devices 106B-106D. The method flowchart 500 starts at step 502.

At step 504, the first device 106A may connect to a mobile device 108A over a short-range network 112. This has been discussed in greater details in FIGS. 1A, 1B and 1C above.

At step 506, the first device 106A may determine one or more unconfigured devices 106B-106D by broadcasting a discover message (i.e. M_DISCOVER_UNCONFIGURED) by the first device 106A over the short-range network 112. This has been discussed in greater details in FIGS. 1A, 1B and 1C above.

At step 508, the first device 106A may receive an identity message (i.e. M_REQ_IDENTITY) from the one or more unconfigured devices 106B-106D in response to the discover message. This has been discussed in greater details in FIGS. 1A, 1B and 1C above.

At step 510, the first device 106A may configure the one or more unconfigured devices 106B-106D over the short-range network 112 in response to receiving the identity message. This has been discussed in greater details in FIGS. 1A, 1B and 1C above. Then, the method flowchart 500 may end at 512.

In one embodiment of the invention, the invention can be operated using the one or more computer readable devices. The one or more computer readable devices can be associated with a first device 106A. A computer readable medium comprises one or more processors and a memory coupled to the one or more processors, the memory stores instructions executed by the one or more processors. The one or more processors configured to connect a first device 106A to a mobile device 108 over a short-range network 112 and to determine one or more unconfigured devices 106B-106D by broadcasting a discover message by the first device 106A over the short-range network 112. The one or more processors are also configured to receive an identity message from the one or more unconfigured devices 106B-106D in response to the discover message. The one or more processors are also configured to configure the one or more unconfigured devices 106B-106D over the short-range network 112 in response to receiving the identity message.

The present invention is applicable in various industries/fields such as, but is not limited to, banking industry, hospitality industry, housing industry, building/construction industry, offices, universities, hospitals, colleges, homes and any such industry/field that is well known in the art and where the devices 106 are used.

The embodiments of the invention discussed herein are exemplary and various modification and alterations to a person skilled in the art are within the scope of the invention.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “controller” can refer to substantially any processor or computing processing unit or device comprising, but not limited to comprising, a direct digital control of a HVAC system, a zone controller of the HVAC system, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

what is claimed is:

1. A method comprising:
establishing a connection by a mobile device with a first device over a short-range network;
enabling the first device to determine one or more unconfigured devices by broadcasting a discover message by the first device over the short-range network; and
enabling the first device to configure the one or more unconfigured devices over the short-range network in response to determination of the one or more unconfigured devices.

2. The method of claim 1, further comprising, communicating with the first device and the one or more unconfigured devices with different broadcast and/or unicast commands over the short-range network, wherein the broadcast and/or unicast commands are transmitted over a data frame to configure the one or more unconfigured devices.

3. The method of claim 1, wherein the short-range network is a Wi-Fi network.

4. The method of claim 1, wherein the first device transmits an encrypted configuration information to the one or more unconfigured devices for configuring the one or more unconfigured devices, wherein the one or more unconfigured devices decrypt the encrypted configuration information.

5. The method of claim 1, further comprising, changing from an unconfigured status to a configured status of the one or more unconfigured devices after configuring the one or more unconfigured devices.

6. The method of claim 5, further comprising, enabling the first device to transmit a blink command to one or more configured devices to locate or identify the configured devices.

7. The method of claim 1, wherein the first device is connected to a short-range network dongle for communicating with the mobile device over the short-range network.

8. The method of claim 1, wherein the first device configures the one or more unconfigured devices simultaneously and/or iteratively over the short-range network.

9. The method of claim 1, wherein the configuration of the first device by the mobile device and the configuration of the one or more unconfigured devices by the first device is performed at a data link layer.

10. The method of claim 1, wherein the first device determines the one or more unconfigured devices when the first device receives an identity message from the one or more unconfigured devices.

11. The method of claim 1, wherein the first device reconfigures and/or unconfigures one or more configured devices.

12. A method comprising:
connecting a first device to a mobile device over a short-range network;
determining one or more unconfigured devices by broadcasting a discover message by the first device over the short-range network;
receiving an identity message from the one or more unconfigured devices in response to the discover message; and
configuring the one or more unconfigured devices over the short-range network in response to receiving the identity message.

13. The method of claim 12, further comprising, receiving an acknowledgment message after configuring the one or more unconfigured devices.

14. A system comprising:
a mobile device configured to establish a connection with a first device over a short-range network; and
the first device configured to:
determine one or more unconfigured devices by broadcasting a discover message over the short-range network;
receive an identity message from the one or more unconfigured devices in response to the discover message; and
configure the one or more unconfigured devices in response to receiving the identity message.

15. The system of claim 14, wherein the mobile device communicates with the first device and the one or more unconfigured devices with different broadcast and/or unicast commands over the short-range network, wherein the broadcast and/or unicast commands are transmitted over a data frame to configure the one or more unconfigured devices.

16. The system of claim 14, wherein the mobile device enables the first device to reconfigure and/or unconfigure one or more configured devices.

17. The system of claim 14, wherein the first device transmits an encrypted configuration information to the one or more unconfigured devices for configuring the one or more unconfigured devices, wherein the one or more unconfigured devices decrypt the encrypted configuration information.

18. The system of claim 14, wherein the first device is configured to change from an unconfigured status to a configured status of the one or more unconfigured devices after configuring the one or more unconfigured devices.

19. The system of claim 14, wherein the configuration of the first device by the mobile device and the configuration of the one or more unconfigured devices by the first device is performed at a data link layer.

20. A computer readable medium comprising one or more processors and a memory coupled to the one or more processors, the memory storing instructions executed by the one or more processors, the one or more processors configured to:
connect a first device to a mobile device over a short-range network;
determine one or more unconfigured devices by broadcasting a discover message by the first device over the short-range network;
receive an identity message from the one or more unconfigured devices in response to the discover message; and
configure the one or more unconfigured devices over the short-range network in response to receiving the identity message.
